(19) United States
(12) Patent Application Publication
(10) Pub. No.: US 2026/0041126 A1
(43) Pub. Date: Feb. 12, 2026

(54) BEVERAGE CONTAINING HIGH POTENCY SWEETENERS

(71) Applicant: Red Bull GmbH, Fuschl am See (AT)

(72) Inventors: Andrea Hitzfeld, Fuschl am See (AT); Stefanie Holper, Fuschl am See (AT)

(21) Appl. No.: 19/295,298

(22) Filed: Aug. 8, 2025

(30) Foreign Application Priority Data
Aug. 9, 2024 (EP) 24193903.2

(51) Int. Cl. A23L 2/60; A23L 2/38; A23L 2/40; A23L 2/56; A23L 2/68

(52) U.S. Cl. CPC A23L 2/60; A23L 2/38; A23L 2/40; A23L 2/56; A23L 2/68

(57) ABSTRACT

A beverage contains sucralose, water, malic acid, and lactic acid. Also disclosed is a beverage containing one or more high potency sweeteners, water, and 0.001 to 0.2 wt.-% malic acid and/or 0.05 to 0.6 wt.-% lactic acid. Lactic acid and malic acid and optionally citric acid are used in combination in a beverage containing high potency sweeteners for reducing or masking a sweet aftertaste or lingering effect of the high potency sweeteners or for improving the sensory profile of the beverage containing high potency sweeteners. The lactic acid and malic acid and optionally citric acid are also used in combination in a beverage containing high potency sweeteners and at least one flavor compound for enhancing and/or prolonging the flavor impression of the flavor compound.

### BACKGROUND

### Technical Field

The present disclosure relates to a beverage containing one or more high potency sweeteners as well as malic acid and/or lactic acid, in some cases malic acid and lactic acid, and in some other cases malic acid, lactic acid and citric acid. It further relates to the use of lactic acid and malic acid and in some cases citric acid in a beverage containing at least one high potency sweetener for reducing or masking the sweet aftertaste or the lingering effect caused by said high potency sweeteners or for improving the sensory profile of said beverage containing high potency sweeteners or for enhancing and/or prolonging the flavor impression of a flavor compound in said beverage.

### Description of the Related Art

There exist longstanding efforts to replace natural sugars in soft drinks and energy drinks by low or non-caloric natural or artificial high potency sweeteners such as rebaudiosides, monatin, thaumatin, brazzein, sucralose, cyclamate, aspartame and acesulfame. These beverages despite having a rather low calorie content are still lacking comprehensive acceptance among customers due to their sensory disadvantages. Both low-or non-caloric natural and artificial high potency sweeteners are known to cause in various degrees a bitter, licorice-like or metallic aftertaste or a blunt or dry mouthfeel. In many instances, these low-or non-caloric natural and artificial high potency sweeteners have a delayed sweetness sensation, that is, the sweetening has a significant onset time which significantly irritates the consumer.

Many attempts have been made to overcome the afore-mentioned shortcomings. For example, according to WO 2012/073121 A2 the bitter aftertaste of steviol glycosides shall be decreased or eliminated by the reduction or elimination of rebaudioside C or dulcoside A or both from stevia compositions. However, even with stevia compositions being void of rebaudioside C or dulcoside A consumers experience a slow onset and sometimes even a longer duration of the sweetness sensation.

Sweetened beverage formulations which do not exhibit a bitter aftertaste shall be obtained according to EP 2 474 240 A1 by use of rebaudioside D and an acidulant comprising at least lactic acid and one or both of tartaric acid and citric acid, and no phosphoric acid.

From WO 2011/146463 A2 it can be derived that the bitterness in an otherwise sweet composition containing steviol glycosides shall be masked by incorporating an increased amount, relative to naturally occurring compositions, of rebaudioside D.

According to WO 2008/112967 A1 the metallic aftertaste experienced with beverages containing conventional steviol glycosides may be masked by the presence of anisic acid.

And, in WO 2012/109585 A1 it is disclosed that attributes such as bitterness, sweet aftertaste and licorice flavor of steviol glycosides may be overcome by sweetening compositions comprising a blend of rebaudioside A, rebaudioside B and steviol glycosides, in some cases when the ratio of rebaudioside B to total steviol glycosides in the blend ranges from 0.5% to about 50% and in some cases from about 5% to about 40%.

In view of existing solutions for low calorie beverages it is still desirable to arrive at a much improved sweetness and aroma profile, in some cases in a cost-effective manner.

Thus, there is accordingly a need to provide low or non-calorie beverages which do not exhibit the disadvantages of the prior art sweetening compositions, and which in some cases provide a less intensive sweetness aftertaste. Further, there is also a need to provide beverages which have a satisfactory sweetness profile, in some cases also as to the duration of perceiving sweetness, similar to sucrose.

### BRIEF SUMMARY

The problems underlying the present disclosure have surprisingly been solved by a beverage, in some cases a carbonated beverage such as an energy drink, containing a) sucralose as high potency sweetener, b) water, c) malic acid, in some cases in the amount in the range of 0.001 to 0.20 wt.-%, in some other cases 0.005 to 0.15 wt.-%, in some even other cases 0.01 to 0.10 wt.-% and in some further cases 0.015 to 0.05 wt.-%, based on the total weight of the beverage in each case, and d) lactic acid, in some cases in the amount in the range of 0.05 to 0.60 wt.-%, in some other cases 0.10 to 0.50 wt.-%, in some even other cases 0.15 to 0.40 wt.-% and in some further cases 0.20 to 0.30 wt.-%, based on the total weight of the beverage in each case.

The combined use of malic acid and lactic acid together with at least one high potency sweetener, in some cases at least one artificial high potency sweetener, has been found to yield a very harmonic sensory profile, in some cases in terms of sweetness perception and reduced lingering effect.

### DETAILED DESCRIPTION

Based on the foregoing beverage composition, those are highly expedient which further comprise in a first alternative i) saccharin, in some cases sodium saccharin, and cyclamate, in some cases sodium cyclamate, as high potency sweeteners a), and in a second alternative ii) mogroside V as high potency sweetener a). Beverages of the present disclosure according to the first alternative i) and the second alternative ii) furnish satisfactory results which in addition contain acesulfame, in some cases acesulfame potassium, as high potency sweetener a). Features in embodiments described as “expedient” are understood to be optional, in some cases including preferred, alternative, and/or additional features.

According to an expedient embodiment, the beverage of the present disclosure comprises a) sucralose as high potency sweetener and no other high potency sweetener, b) water, c) malic acid, d) lactic acid, f) citric acid and g) erythritol.

According to further expedient embodiment, the beverage of the present disclosure comprises a) sucralose, saccharin, in some cases sodium saccharin, and cyclamate, in some cases sodium cyclamate, and optionally also acesulfame, in some cases acesulfame potassium, as high potency sweeteners, b) water, c) malic acid and d) lactic acid, and even more expediently a) sucralose, saccharin, in some cases sodium saccharin, and cyclamate, in some cases sodium cyclamate, and in some cases also acesulfame, in some cases acesulfame potassium, as high potency sweeteners, b) water, c) malic acid, d) lactic acid, f) citric acid and g) erythritol. Even more expediently, the beverages of the present disclosure outlined in this paragraph do not contain any other high potency sweetener as explicitly specified.

According to another expedient embodiment, the beverage of the present disclosure comprises a) sucralose and mogroside V, and in some cases also acesulfame, in some cases acesulfame potassium, as high potency sweeteners, b) water, c) malic acid and d) lactic acid, and even more expediently a) sucralose and mogroside V, and in some cases also acesulfame, in some cases acesulfame potassium, as high potency sweeteners, b) water, c) malic acid, d) lactic acid, f) citric acid and g) erythritol. Even more expediently, the beverage of the present disclosure outlined in this paragraph do not contain any other high potency sweetener as explicitly specified.

In the aforementioned embodiments of the beverage of the present disclosure c) malic acid is in some cases present in the beverage in an amount in the range of 0.001 to 0.20 wt.-%, in some cases 0.005 to 0.15 wt.-%, in some other cases 0.01 to 0.10 wt.-% and in some even other cases 0.015 to 0.05 wt.-%, based on the total weight of the beverage in each case, and d) lactic acid is in some cases present in the beverage in an amount in the range of 0.05 to 0.60 wt.-%, in some cases 0.10 to 0.50 wt.-%, in some other cases 0.15 to 0.40 wt.-% and in some even other cases 0.20 to 0.30 wt.-%, based on the total weight of the beverage in each case.

Accordingly, in some cases embodiments of the present disclosure provide a beverage containing a) sucralose, saccharin, in some cases sodium saccharin, and cyclamate, in some cases sodium cyclamate, as high potency sweeteners, and in some cases no other high potency sweetener, b) water, c) malic acid and d) lactic acid and in some cases also f) citric acid.

In some cases, the present disclosure provides a beverage containing a) sucralose, saccharin, in some cases sodium saccharin, cyclamate, in some cases sodium cyclamate, and acesulfame, in some cases acesulfame potassium, as high potency sweeteners, and in some cases no other high potency sweetener, b) water, c) malic acid and d) lactic acid and in some cases also f) citric acid.

In some cases, the present disclosure provides a beverage containing a) sucralose, saccharin, in some cases sodium saccharin, and cyclamate, in some cases sodium cyclamate, as high potency sweeteners, and in some cases no other high potency sweetener, b) water, c) malic acid, d) lactic acid and g) erythritol, and in some cases also f) citric acid.

In some cases, the present disclosure provides a beverage containing a) sucralose, saccharin, in some cases sodium saccharin, cyclamate, in some cases sodium cyclamate, and acesulfame, in some cases acesulfame potassium, as high potency sweeteners, and in some cases no other high potency sweetener, b) water, c) malic acid, d) lactic acid and g) erythritol, and in some cases also f) citric acid.

In some cases, the present disclosure provides a beverage containing a) sucralose, acesulfame, in some cases acesulfame potassium, and mogroside V as high potency sweeteners, and in some cases no other high potency sweetener, b) water, c) malic acid, and d) lactic acid, and in some cases also f) citric acid.

In some cases, the present disclosure provides a beverage containing a) sucralose, acesulfame, in some cases acesulfame potassium, and mogroside V as high potency sweeteners, and in some cases no other high potency sweetener, b) water, c) malic acid, d) lactic acid, and g) erythritol, and in some cases also f) citric acid.

Furthermore, in some cases the present disclosure provides a beverage containing a) sucralose as the high potency sweetener, and in some cases no other high potency sweetener, b) water, c) malic acid, d) lactic acid, and g) erythritol, and in some cases also f) citric acid.

In some cases, the present disclosure provides a highly expedient beverage, which contains
a) one or more high potency sweeteners,
b) water, and
c) 0.001 to 0.20 wt.-%, in some cases 0.005 to 0.15 wt.-%, in some other cases 0.01 to 0.10 wt.-% and in some even other cases 0.015 to 0.05 wt.-%, malic acid, based on the total weight of the beverage in each case, or
d) 0.05 to 0.60 wt.-%, in some cases 0.10 to 0.50 wt.-%, in some other cases 0.15 to 0.40 wt.-% and in some even other cases 0.20 to 0.30 wt.-%, lactic acid, based on the total weight of the beverage in each case.

In an even more expedient embodiment, the present disclosure provides a beverage containing
a) one or more high potency sweeteners,
b) water, and
c) 0.001 to 0.20 wt.-%, in some cases 0.005 to 0.15 wt.-%, in some other cases 0.01 to 0.10 wt.-% and in some even other cases 0.015 to 0.05 wt.-%, malic acid, based on the total weight of the beverage in each case, and
d) 0.05 to 0.60 wt.-%, in some cases 0.10 to 0.50 wt.-%, in some other cases 0.15 to 0.40 wt.-% and in some even other cases 0.20 to 0.30 wt.-%, lactic acid, based on the total weight of the beverage in each case.

The beverage of the present disclosure can further comprise in expedient embodiments at least one flavor compound (component e)). Suitable flavor compounds are based on flavorings selected from the group consisting of fruit flavors such as citrus fruit flavors, in some cases lemon flavor, herbal flavors, blossom flavors, licorice flavors, vanilla flavors and cinnamon flavors. In some cases, flavor compounds have flavorings selected from the group consisting of apple flavor, apricot flavor, Bergamot flavor, blackberry flavor, caramel flavor, cherry flavor, cinnamon flavor, citron flavor, coconut flavor, cola flavor, cranberry flavor, elderberry flavor, ginger flavor, gooseberry flavor, grape flavor, grapefruit flavor, hibiscus flavor, jasmine flavor, lavender flavor, lemon flavor, lime flavor, litchi flavor, malt flavor, mango flavor, mate flavor, melon flavor, mint flavor, orange flavor, passionfruit flavor, peach flavor, pear flavor, pineapple flavor, plum flavor, pomegranate flavor, raspberry flavor, rose flavor, starfruit flavor, strawberry flavor, vanilla flavor, and watermelon flavor.

Those beverages of the present disclosure are highly expedient in which the amount of malic acid in the beverage, based on the combined weight of malic acid and lactic acid, is in the range of 2.0 to 15.0 wt.-%, in some cases in the range of 4.0 to 12.0 wt.-%, in some other cases in the range of 5.0 to 10.0 wt.-% and in some even other cases in the range of 6.0 to 9.0 wt.-%. These embodiments help to balance the low-or non-caloric high potency sweeteners and furnish a more pleasant aroma profile and a reduced lingering sweetness.

The effect of lingering sweetness of low-or non-caloric high potency sweeteners can also be reduced, in some cases if combined with malic acid, in some other cases if combined with malic acid in the amounts as specified in the foregoing paragraph, by a beverage according to the present disclosure in which the amount of lactic acid in the beverage, based on the combined weight of malic acid and lactic acid, is in the range of 85.0 to 98.0 wt.-%, in some cases in the range of 88.0 to 96.0 wt.-%, in some other cases in the range of 90.0 to 95.0 wt.-% and in some even other cases in the range of 91.0 to 94.0 wt.-%.

Suitable high potency sweeteners of the beverages of the present disclosure can be selected from the group consisting of natural high potency sweeteners, artificial high potency sweeteners and a mixture thereof. Suitable natural high potency sweeteners can be selected from the group consisting of Monk's Fruit extract, Lo Han Guo extract, Stevia extracts, in some cases Stevia leaf extracts, steviol glycosides, rebaudiosides, steviosides, enzymatically produced steviol glycosides, glucosylated steviol glycosides, mogroside V, mogroside IV, monatin, glycyrrhizin, thaumatin, brazzein, monellin and mixtures thereof, while suitable artificial high potency sweeteners can be selected from the group consisting of sucralose, saccharin, in some cases sodium saccharin, cyclamate, in some cases sodium cyclamate, acesulfame, in some cases acesulfame potassium, advantame, aspartame, neotame, neohesperidine and mixtures thereof.

High potency sweeteners, also known as high intensity sweeteners or high intense sweeteners, are compounds having many times the sweetness of sucrose. For example, acesulfame potassium is 200 times sweeter than sucrose, aspartame is about 180 to 200 times sweeter than sucrose, saccharine is about 300 to 500 times sweeter than sucrose, and sucralose is about 600 times sweeter than sucrose.

Highly expedient beverages of the present disclosure further comprise citric acid (component f)). By combined use of malic acid and citric acid or lactic acid and citric acid, and in some cases by the combined use of malic acid, lactic acid and citric acid the sweet aftertaste of the low-or non-caloric high potency sweeteners, i.e., the lingering sweetness effect can be very significantly reduced thereby arriving at a sweetening profile similar to beverages sweetened with sucrose. It has been found that the use of the combination of the three acids lactic acid, citric acid and malic acid, in some cases in the amounts specified in this description, improves the general sensory profile of beverages such as energy drinks and carbonated soft drinks.

In expedient embodiments, the beverage of the present disclosure comprises, in some cases in addition to malic acid and lactic acid, citric acid in the range of 0.05 to 0.80 wt.-%, in some cases 0.10 to 0.60 wt.-%, in some other cases 0.15 to 0.40 wt.-% and in some even other cases 0.20 to 0.30 wt.-%, based on the total weight of the beverage in each case.

The beverage of the present disclosure can further comprise acetic acid, fumaric acid, tartaric acid, phosphoric acid, succinic acid, cinnamic acid, maleic acid, adipic acid, glutaric acid, succinic acid, gluconic acid, glycolic acid, mandelic acid, oxalic acid or salicylic acid or mixtures thereof. However, in expedient embodiments the beverages of the present disclosure do not contain any other acid than malic acid and lactic acid or, in some cases, no other acid than malic acid, lactic acid and citric acid.

Highly expedient embodiments of the beverage of the present disclosure comprise, in some cases in addition to the combination of malic acid, lactic acid and citric acid, erythritol (component g)). Erythritol is in some cases present in the beverages of the present disclosure in an amount, based on the total weight of the beverage, in the range of 0.5 to 3.5 wt.-%, in some cases in the range of 1.0 to 2.0 wt.-%.

The beverage of the present disclosure can further comprise glycerol, lactitol, maltitol, mannitol, sorbitol, xylitol or galactitol or mixtures thereof.

The sweet aftertaste of the low-or non-caloric high potency sweeteners, i.e., the lingering sweetness effect can in some cases be reduced and a sweetening profile similar to beverages sweetened with sucrose can be obtained with beverages according to the present disclosure in which the amount of malic acid in the beverage, based on the combined weight of malic acid, lactic acid and citric acid, is in the range of 1.0 to 10.0 wt.-%, in some cases in the range of 2.0 to 8.0 wt.-%, in some other cases in the range of 2.5 to 6.0 wt.-%, and in some even other cases in the range of 3.0 to 5.0 wt.-%, in which further the amount of lactic acid in the beverage, based on the combined weight of malic acid, lactic acid and citric acid, is in the range of 45.0 to 49.5 wt.-%, in some cases in the range of 46.0 to 49.0 wt.-%, in some even other cases in the range of 47.0 to 48.7 wt.-% and in some further cases in the range of 47.5 to 48.5 wt.-%, and in which in addition the amount of citric acid in the beverage, based on the combined weight of malic acid, lactic acid and citric acid, is in the range of 45.0 to 49.5 wt.-%, in some cases in the range of 46.0 to 49.0 wt.-%, in some even other cases in the range of 47.0 to 48.7 wt.-% and in some further cases in the range of 47.5 to 48.5 wt.-%.

It has also surprisingly been found that a very satisfactory taste profile can be accomplished with beverages according to the present disclosure which also contain rubusosides, in some cases in an amount in the range of 0.0001 to 0.02 wt.-%, in some other cases in the range of 0.0005 to 0.01 wt.-%, in some even other cases in the range of 0.001 to 0.007 wt.-%, and in some further cases in the range of 0.0015 to 0.005 wt.-%, based on the total weight of the beverage in each case. In some cases, by working within the aforementioned ranges the sweetness perception of the beverages of the present disclosure can be increased without having to accept sensory disadvantages.

Those beverages of the present disclosure are expedient in terms of arriving at a less intensive sweet aftertaste and an improved general sensory profile, in some cases in energy drinks and carbonated soft drinks, which contain sucralose, saccharin, in some cases sodium saccharin, and cyclamate, in some cases sodium cyclamate, or which contain sucralose, saccharin, in some cases sodium saccharin, cyclamate, in some cases sodium cyclamate, and acesulfame, in some cases acesulfame potassium, or which in some cases contain sucralose, saccharin, in some cases sodium saccharin, cyclamate, in some cases sodium cyclamate, and erythritol, or which in some cases contain sucralose, saccharin, in some cases sodium saccharin, cyclamate, in some cases sodium cyclamate, acesulfame, in some cases acesulfame potassium, and erythritol. Furthermore, those beverages of the present disclosure are highly expedient in terms of arriving at a less intensive sweet aftertaste and an improved general sensory profile, in some cases in energy drinks and carbonated soft drinks, which contain sucralose, saccharin, in some cases sodium saccharin, and cyclamate, in some cases sodium cyclamate, and no other high potency sweetener, or which contain sucralose, saccharin, in some cases sodium saccharin, cyclamate, in some cases sodium cyclamate, and acesulfame, in some cases acesulfame potassium, and no other high potency sweetener, or which in some cases contain sucralose, saccharin, in some cases sodium saccharin, cyclamate, in some cases sodium cyclamate, and erythritol, and no other high potency sweetener, or which in some cases contain sucralose, saccharin, in some cases sodium saccharin, cyclamate, in some cases sodium cyclamate, acesulfame, in some cases acesulfame potassium, and erythritol, and no other high potency sweetener.

In the beverages of the present disclosure as specified in the foregoing paragraph, the amount of sucralose in the beverage, based on the total weight of the beverage, is in some cases in the range of 0.001 to 0.10 wt.-%, in some other cases in the range of 0.004 to 0.07 wt.-%, and in some even other cases in the range of 0.006 to 0.05 wt.-%, or the amount of saccharin, in some cases sodium saccharin, in the beverage, based on the total weight of the beverage, is in the range of 0.0001 to 0.02 wt.-%, in some cases in the range of 0.0005 to 0.01 wt.-%, and in some other cases in the range of 0.001 to 0.008 wt.-%, or the amount of cyclamate, in some cases sodium cyclamate, in the beverage, based on the total weight of the beverage, is in the range of 0.001 to 0.1 wt.-%, in some cases in the range of 0.004 to 0.07 wt.-%, and in some even other cases in the range of 0.006 to 0.05 wt.-%, or the amount of acesulfame, in some cases acesulfame potassium, in the beverage, based on the total weight of the beverage, is in the range of 0.001 to 0.10 wt.-%, in some cases in the range of 0.004 to 0.07 wt.-%, and in some other cases in the range of 0.006 to 0.05 wt.-%, or the amount of erythritol in the beverage, based on the total weight of the beverage, is in the range of 0 to 10.0 wt.-%, in some cases in the range of 0.5 to 5.0 wt.-%, and in some other cases in the range of 1.0 to 3.0 wt.-%.

In the beverages of the present disclosure which contain sucralose, saccharin, in some cases sodium saccharin, and cyclamate, in some cases sodium cyclamate, the amount of sucralose in the beverage, based on the total weight of the beverage, is in some cases in the range of 0.001 to 0.10 wt.-%, in some cases in the range of 0.004 to 0.07 wt.-%, and in some even other cases in the range of 0.006 to 0.05 wt.-%, the amount of saccharin, in some cases sodium saccharin, in the beverage, based on the total weight of the beverage, is in the range of 0.0001 to 0.02 wt.-%, in some other cases in the range of 0.0005 to 0.01 wt.-%, and in some even other cases in the range of 0.001 to 0.008 wt.-%, and the amount of cyclamate, in some cases sodium cyclamate, in the beverage, based on the total weight of the beverage, is in the range of 0.001 to 0.10 wt.-%, in some cases in the range of 0.004 to 0.07 wt.-%, and in some other cases in the range of 0.006 to 0.05 wt.-%.

In the beverages of the present disclosure which contain sucralose, saccharin, in some cases sodium saccharin, cyclamate, in some cases sodium cyclamate, and erythritol the amount of sucralose in the beverage, based on the total weight of the beverage, is in some cases in the range of 0.001 to 0.10 wt.-%, in some other cases in the range of 0.004 to 0.07 wt.-%, and in some even other cases in the range of 0.006 to 0.05 wt.-%, the amount of saccharin, in some cases sodium saccharin, in the beverage, based on the total weight of the beverage, is in the range of 0.0001 to 0.02 wt.-%, in some cases in the range of 0.0005 to 0.01 wt.-%, and in some other cases in the range of 0.001 to 0.008 wt.-%, the amount of cyclamate, in some cases sodium cyclamate, in the beverage, based on the total weight of the beverage, is in the range of 0.001 to 0.10 wt.-%, in some cases in the range of 0.004 to 0.07 wt.-%, and in some other cases in the range of 0.006 to 0.05 wt.-%, and the amount of erythritol in the beverage, based on the total weight of the beverage, is in the range of 0 to 10.0 wt.-%, in some cases in the range of 0.5 to 5.0 wt.-%, and in some other cases in the range of 1.0 to 3.0 wt.-%.

In the beverages of the present disclosure which contain sucralose, saccharin, in some cases sodium saccharin, cyclamate, in some cases sodium cyclamate, and acesulfame, in some cases acesulfame potassium, the amount of sucralose in the beverage, based on the total weight of the beverage, is in some cases in the range of 0.001 to 0.10 wt.-%, in some cases in the range of 0.004 to 0.07 wt.-%, and in some other cases in the range of 0.006 to 0.05 wt.-%, the amount of saccharin, in some cases sodium saccharin, in the beverage, based on the total weight of the beverage, is in the range of 0.0001 to 0.02 wt.-%, in some cases in the range of 0.0005 to 0.01 wt.-%, and in some other cases in the range of 0.001 to 0.008 wt.-%, the amount of cyclamate, in some cases sodium cyclamate, in the beverage, based on the total weight of the beverage, is in the range of 0.001 to 0.1 wt.-%, in some cases in the range of 0.004 to 0.07 wt.-%, and in some other cases in the range of 0.006 to 0.05 wt.-%, and the amount of acesulfame, in some cases acesulfame potassium, in the beverage, based on the total weight of the beverage, is in the range of 0.001 to 0.10 wt.-%, in some cases in the range of 0.004 to 0.07 wt.-%, and in some other cases in the range of 0.006 to 0.05 wt.-%.

In the beverages of the present disclosure which contain sucralose, saccharin, in some cases sodium saccharin, cyclamate, in some cases sodium cyclamate, acesulfame, in some cases acesulfame potassium, and erythritol, the amount of sucralose in the beverage, based on the total weight of the beverage, is in some cases in the range of 0.001 to 0.10 wt.-%, in some cases in the range of 0.004 to 0.07 wt.-%, and in some other cases in the range of 0.006 to 0.05 wt.-%, the amount of saccharin, in some cases sodium saccharin, in the beverage, based on the total weight of the beverage, is in the range of 0.0001 to 0.02 wt.-%, in some cases in the range of 0.0005 to 0.01 wt.-%, and in some other cases in the range of 0.001 to 0.008 wt.-%, the amount of cyclamate, in some cases sodium cyclamate, in the beverage, based on the total weight of the beverage, is in the range of 0.001 to 0.1 wt.-%, in some cases in the range of 0.004 to 0.07 wt.-%, and in some other cases in the range of 0.006 to 0.05 wt.-%, the amount of acesulfame, in some cases acesulfame potassium, in the beverage, based on the total weight of the beverage, is in the range of 0.001 to 0.10 wt.-%, in some cases in the range of 0.004 to 0.07 wt.-%, and in some other cases in the range of 0.006 to 0.05 wt.-%, and the amount of erythritol in the beverage, based on the total weight of the beverage, is in the range of 0 to 10.0 wt.-%, in some cases in the range of 0.5 to 5.0 wt.-%, and in some other cases in the range of 1.0 to 3.0 wt.-%.

The aforementioned ranges for beverages containing sucralose, saccharin, in some cases sodium saccharin, and cyclamate, in some cases sodium cyclamate, or sucralose, saccharin, in some cases sodium saccharin, cyclamate, in some cases sodium cyclamate, and acesulfame, in some cases acesulfame potassium, are also applicable for beverages which do not contain any other high potency sweetener than those explicitly specified.

Those beverages of the present disclosure are also expedient in terms of arriving at a less intensive sweet aftertaste and an improved general sensory profile, in some cases in energy drinks and carbonated soft drinks, which contain sucralose, acesulfame, in some cases acesulfame potassium, and mogroside V, or which contain sucralose, acesulfame, in some cases acesulfame potassium, mogroside V, and erythritol.

In the beverages of the present disclosure as specified in the foregoing paragraph, the amount of sucralose in the beverage, based on the total weight of the beverage, is in the range of 0.001 to 0.10 wt.-%, in some cases in the range of 0.004 to 0.07 wt.-%, and in some other cases in the range of 0.006 to 0.05 wt.-%, or the amount of acesulfame, in some cases acesulfame potassium, in the beverage, based on the total weight of the beverage, is in the range of 0.001 to 0.10 wt.-%, in some cases in the range of 0.004 to 0.07 wt.-%, and in some other cases in the range of 0.006 to 0.05 wt.-%, or the amount of mogroside V in the beverage, based on the total weight of the beverage, is in the range of 0.0015 to 0.10 wt.-%, in some cases in the range of 0.004 to 0.07 wt.-%, and in some other cases in the range of 0.006 to 0.05 wt.-%, or, if present in the beverage, the amount of erythritol in the beverage, based on the total weight of the beverage, is in the range of 0 to 10.0 wt.-%, in some cases in the range of 0.5 to 5.0 wt.-%, and in some other cases in the range of 1.0 to 3.0 wt.-%.

In the beverages of the present disclosure which contain sucralose, acesulfame, in some cases acesulfame potassium, and mogroside V, the amount of sucralose in the beverage, based on the total weight of the beverage, is in the range of 0.001 to 0.10 wt.-%, in some cases in the range of 0.004 to 0.07 wt.-%, and in some other cases in the range of 0.006 to 0.05 wt.-%, the amount of acesulfame, in some cases acesulfame potassium, in the beverage, based on the total weight of the beverage, is in the range of 0.001 to 0.10 wt.-%, in some cases in the range of 0.004 to 0.07 wt.-%, and in some other cases in the range of 0.006 to 0.05 wt.-%, and the amount of mogroside V in the beverage, based on the total weight of the beverage, is in the range of 0.0015 to 0.10 wt.-%, in some cases in the range of 0.004 to 0.07 wt.-%, and in some other cases in the range of 0.006 to 0.05 wt.-%.

In the beverages of the present disclosure which contain sucralose, acesulfame, in some cases acesulfame potassium, mogroside V, and erythritol the amount of sucralose in the beverage, based on the total weight of the beverage, is in the range of 0.001 to 0.10 wt.-%, in some cases in the range of 0.004 to 0.07 wt.-%, and in some other cases in the range of 0.006 to 0.05 wt.-%, the amount of acesulfame, in some cases acesulfame potassium, in the beverage, based on the total weight of the beverage, is in the range of 0.001 to 0.10 wt.-%, in some cases in the range of 0.004 to 0.07 wt.-%, and in some other cases in the range of 0.006 to 0.05 wt.-%, the amount of mogroside V in the beverage, based on the total weight of the beverage, is in the range of 0.0015 to 0.10 wt.-%, in some cases in the range of 0.004 to 0.07 wt.-%, and in some other cases in the range of 0.006 to 0.05 wt.-%, or, if present in the beverage, and the amount of erythritol in the beverage, based on the total weight of the beverage, is in the range of 0 to 10.0 wt.-%, in some cases in the range of 0.5 to 5.0 wt.-%, and in some other cases in the range of 1.0 to 3.0 wt.-%.

The aforementioned ranges for beverages containing sucralose, acesulfame, in some cases acesulfame potassium, and mogroside V, or containing sucralose, acesulfame, in some cases acesulfame potassium, mogroside V, and erythritol are also applicable for beverages which do not contain any other high potency sweetener.

Mogroside V is the main component of the Siraitia grosvenorii fruit, also known as monk's fruit, luohan guo, or Swingle fruit. Mogroside V can be used with the beverages of the present disclosure as such, i.e., in neat form, but can also be added to the beverages as part of an extract of the Siraitia grosvenorii fruit.

Those beverages of the present disclosure are also expedient in terms of arriving at a less intensive sweet aftertaste and an improved general sensory profile, in some cases in energy drinks and carbonated soft drinks, which contain sucralose and erythritol.

In the beverages of the present disclosure as specified in the foregoing paragraph, the amount of sucralose in the beverage, based on the total weight of the beverage, is in the range of 0.010 to 0.050 wt.-%, in some cases in the range of 0.015 to 0.040 wt.-%, and in some cases in the range of 0.020 to 0.030 wt.-%, and the amount of erythritol in the beverage, based on the total weight of the beverage, is in the range of 0 to 10.0 wt.-%, in some cases in the range of 0.5 to 5.0 wt.-%, and in some other cases in the range of 1.0 to 3.0 wt.-%.

The aforementioned ranges for beverages containing sucralose and erythritol are also applicable for beverages which do not contain any other high potency sweetener.

The components that form the beverages of the present disclosure add up in each case to exactly 100 wt.-%.

The beverage of the present disclosure can be a carbonated beverage, in some cases a soft drink or an energy drink.

With the present disclosure it has the surprisingly been found that by using lactic acid and malic acid in combination in a beverage or by using in some cases lactic acid, malic acid and citric acid in combination in a beverage in each case containing at least one high potency sweetener, in some cases two or more high potency sweeteners, in some cases in a beverage according to the present disclosure, the sweet aftertaste or the lingering effect of said high potency sweeteners can be reduced or masked, or in some cases even be eliminated.

With the present disclosure it has also surprisingly been found that by using lactic acid and malic acid in combination in a beverage or by using in some cases lactic acid, malic acid and citric acid in combination in a beverage in each case containing at least one high potency sweetener, in some cases two or more high potency sweeteners, in some cases in a beverage according to the present disclosure, the sensory profile of said beverage containing high potency sweeteners can be improved.

With the present disclosure it has also surprisingly been found that by using lactic acid and malic acid in combination in a beverage or by using in some cases lactic acid, malic acid and citric acid in combination in a beverage in each case containing at least one high potency sweetener, in some cases two or more high potency sweeteners, and at least one flavor compound, in some cases in a beverage according to the present disclosure, the flavor impression of said flavor compound can be enhanced or prolonged. Surprisingly, by using lactic acid and malic acid in combination in a beverage or by using in some cases lactic acid, malic acid and citric acid in combination as specified in in this paragraph the flavor impression of the flavor compound can be both enhanced and prolonged.

The use of lactic acid and malic acid in combination in a beverage or in some cases of lactic acid, malic acid and citric acid in combination in a beverage as specified in the foregoing paragraphs furnishes highly reliable and reproducible results by making use of a weight ratio of lactic acid to malic acid in the range of (5.0-20.0):1.0, in some cases in the range of (7.5-15.0):1.0, for a combination of lactic acid and malic acid, and by making use of a weight ratio of lactic acid to malic acid to citric acid in the range of (5.0-20.0):1.0:(5.0-20.0), in some cases in the range of (7.5-15.0):1.0:(5.0-20.0), for a combination of lactic acid, malic acid and citric acid.

In those expedient embodiments of the beverages of the present disclosure in which no high potency sweeteners other than those specified for component a) are present, in some cases rubusoside may be present as an exception.

In a highly expedient embodiment, the beverages of the present disclosure do not contain any natural sweet-tasting monosaccharides and do also not contain any natural sweet tasting disaccharides. Sweet-tasting natural monosaccharides encompass for example fructose, glucose, mannose, rhamnose, xylose, tagatose, and galactose, and sweet-tasting natural disaccharides encompass for example sucrose, lactose and maltose or mixtures thereof. In another expedient embodiment the beverages of the present disclosure in addition do also not contain any sweet-tasting sugar alcohols (HOCH₂(CHOH)ₙCH₂OH, e.g., with n=2 to 12), with the exception of erythritol which is in some expedient embodiments of the present disclosure, as outlined in the foregoing, present therein.

Furthermore, the beverage of the present disclosure can also contain at least one thickening agent selected from the group consisting of starch, starch-based thickeners, xanthan, pectin, gum arabic, agar agar, carrageenan, alginic acid and locust bean gum or mixtures thereof and/or, in some cases and, one or more additives selected from the group consisting of vitamins, couleur agents, caffeine, taurine and mixtures thereof.

The pH value of the beverages of the present disclosure is usually in the range from about 2.0 to about 5.0, in some cases in the range from about 2.5 to 4.0.

With the present disclosure, low- or non-calorie beverages have surprisingly been found which although containing high potency sweeteners exhibit a much improved sweetness and aroma profile, and which in some cases have a less intensive sweetness aftertaste thereby arriving at a sensory profile similar to beverages which have been sweetened with sucrose. In other words, with the beverages of the present disclosure, the sweet aftertaste or lingering effect of high potency sweeteners is reduced or masked. Furthermore, with the present disclosure beverages have become accessible in which although containing high potency sweeteners allow a flavor compound to exhibit an enhanced and prolonged flavor impression.

Although modifications and changes may be suggested by those skilled in the art, it is the intention of the applicant to embody within the patent warranted hereon all changes and modifications as reasonably and probably come within the scope of this contribution to the art. The features of the present disclosure which are believed to be novel are set forth in detail in the appended claims. The features disclosed in the description and in the claims could be essential alone or in every combination for the realization of the disclosure in its different embodiments.

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1-26. (canceled)

27. A beverage, containing:
sucralose and mogroside V as high potency sweeteners,
water,
malic acid, and
lactic acid.

28. The beverage according to claim 27, further comprising:
at least one flavor compound.

29. The beverage according to claim 27, further comprising:
citric acid.

30. The beverage according to claim 27, further comprising:
erythritol.

31. The beverage according to claim 29, wherein:
citric acid is present in the beverage in an amount in a range of 0.05 to 0.8 wt.-%, based on the total weight of the beverage.

32. The beverage according to claim 30, wherein:
erythritol is present in the beverage in an amount, based on the total weight of the beverage, in a range of 0.5 to 3.5 wt.-%.

33. The beverage according to claim 27, wherein:
the amount of malic acid in the beverage, based on a combined weight of malic acid and lactic acid, is in a range of 2.0 to 15.0 wt.-%, and/or wherein:
the amount of lactic acid in the beverage, based on a combined weight of malic acid and lactic acid, is in a range of 85.0 to 98.0 wt.-%.

34. The beverage according to claim 29, wherein:
the amount of malic acid in the beverage, based on a combined weight of malic acid, lactic acid, and citric acid, is in a range of 1.0 to 10.0 wt.-%,
the amount of lactic acid in the beverage, based on the combined weight of malic acid, lactic acid, and citric acid, is in a range of 45.0 to 49.5 wt.-%, and
the amount of citric acid in the beverage, based on the combined weight of malic acid, lactic acid, and citric acid, is in a range of 45.0 to 49.5 wt.-%.

35. The beverage according to claim 27, further containing:
rubusosides.

36. The beverage according to claim 27, wherein:
the beverage does not contain any other high potency sweetener than sucralose and mogroside V.

37. The beverage according to claim 27, wherein:
the beverage does not contain any natural sweet-tasting monosaccharides and disaccharides and/or the beverage does not contain any other acid than malic acid and lactic acid.

38. The beverage according to claim 27, wherein:
the beverage is a carbonated beverage.

39. The beverage according to claim 27, wherein:
the beverage contains malic acid in an amount in a range of 0.001 to 0.2 wt.-% based on the total weight of the beverage, and/or wherein:
the beverage contains lactic acid in an amount in a range of 0.05 to 0.6 wt.-% based on the total weight of the beverage.

40. The beverage according to claim 35, wherein:
rubusosides are present in an amount in a range of 0.0001 to 0.02 wt.-% based on the total weight of the beverage.

41. The beverage according to claim 29, wherein:
the beverage does not contain any other acid than malic acid, lactic acid, and citric acid.
